(19) United States
(12) Patent Application Publication
(10) Pub. No.: US 2008/0050592 A1
(43) Pub. Date: Feb. 28, 2008

(54) Particulate Materials

(75) Inventors: Concetta C. Fiannaca, Realmonte (IT); Phillip N. Threlfall-Homes, Durham (GB)

Correspondence Address: JONES DAY, 222 EAST 41ST ST, NEW YORK, NY, 10017, US

(73) Assignee: Imperial Chemical Industries PLC, London (GB)

(21) Appl. No.: 10/583,086

(22) PCT Filed: Dec. 15, 2004
(86) PCT No.: PCT/GB04/05256

§ 371 Date: Sep. 6, 2007

(30) Foreign Application Priority Data
Dec. 17, 2003 (GB) 0329208.3

(51) Int. Cl. B32B 5/16; B29B 9/00

(52) U.S. Cl. 428/402; 264/12

(57) ABSTRACT

Novel particulate materials that have been made by a spray process have at least 80% of particles of the same morphology. The particulate materials also have a mono-dispersivity index of not more than 1.2. In preferred particulate materials, the particles have at least two components, a first component being a matrix material and a second component being an active ingredient retained by said first component. Methods of making such particulate materials are also disclosed.

This invention relates to particulate materials and methods of producing particulate materials.

Particulate materials have found utility in a wide range of applications. For example, encapsulated fragrances and flavours (organoleptics) are widely used in the food/nutrition, home care, eg laundry, and personal care (including cosmetic) fields. Other encapsulated actives, such as biocides, are widely used in the agriculture and hygiene fields. Encapsulated pharmaceutical preparations that permit slow or controlled release of the active ingredient have been widely used. New applications in electronics materials are also generating significant interest.

Particulate materials in which active ingredients are encapsulated within carrier or matrix materials enables the actives to be handled easily and to be readily incorporated within other systems to be dispersed or released, in use, to permit the active ingredient to have its affect. Thus, effective protection of the actives until required, long shelf life, size and density and the controlled or phased release of the active are very important factors in whether such particulate materials are commercially attractive. For example, a wide particle size range may result in a poor dispersion/dissolution of the particles and hence the active in use; or the separating out of the particulate material containing the active ingredient from other particulate materials in a mixture, eg in laundry powders, would be detrimental to the even dispersion of the active in use.

Such particulate materials are generally produced from a liquid precursor by spraying the liquid precursor and, depending on the precursor, either drying it or cooling it to form the particulate materials. The liquid precursor may typically be a melt of a polymer matrix material in which is dispersed an active ingredient in which case the sprayed material is chilled to cause it to at least partially solidify during flight to form substantially spherical particles. Alternatively, the liquid precursor may be a solution or emulsion containing the matrix material and the active ingredient and it is subjected to conditions such as heat to dry it or cause some other phase change sufficient to form the particles during flight.

Spray dryers or chillers are well known and typically consist of a tower into which the liquid precursor is sprayed by an atomiser and in which the liquid droplets are subjected to a gas flow, either co-current or counter-current, to effect at least a partial phase change in the droplets. Commonly used atomisers are single fluid nozzles, two-fluid pneumatic nozzles and high speed rotary disc atomisers. Examples of such spray dryers/atomisers can be found in U.S. Pat. No. 5,545,360, U.S. Pat. No. 564,530, U.S. Pat. No. 6,531,444 and US-A1-2002/0071871. However, such spray equipment tends to produce a relatively wide particle size distribution, including a significant proportion of fines, ie particles with a size less than 30 μm. Although it is possible to refine the size distribution by classifying the particles using screens, cyclone separators etc, the use of such techniques adds significantly to the cost of manufacturing the particulate materials.

Other forms of equipment use different techniques to produce particulate material in which the particle size range is relatively narrow, ie the particles are said to be substantially mono-dispersed. The techniques include applying fluctuating pressure to the liquid being atomised and mechanically or acoustically perturbing the jets of liquid to break them up into droplets. Examples of such equipment can be found in U.S. Pat. No. 4,585,167, GB-A-1454597, EP-A-86704, EP-A-320153 and WO 94/20204. Such equipment has been primarily used to form relatively large prills from a molten precursor such as molten ammonium nitrate.

Particulate materials having a relatively narrow particle size distribution may have advantages over particulate materials having relatively wide particle size distributions. For example, particulate materials having a relatively narrow particle size distribution tend to be less dusty, are free flowing and more easily metered and are safer to handle. However, the Applicant has been found that, even with particulate materials having a relatively narrow particle size distribution, significant difficulties may be experienced in dispersing the particles in liquids in use. Additionally, wetting of the particles by liquids in use and release of the active ingredient is frequently very variable. Those variables are disadvantageous in many applications as they may give rise to poor or incomplete release of the active ingredient in applications such as crop adjuvants, instant foods and laundry products or leave unattractive residues in deodorant/anti-perspirant applications. These issues do not appear to have previously been addressed.

Investigation made by the Applicant has shown that the problems arise owing to the presence in known particulate materials of mixed morphologies. The exception to this is particulate materials produced by spray chilling molten precursor material wherein surface tension effects in the molten droplets tends to produce a substantially spherical morphology. However, in particulate materials formed by spray drying, the Applicant has been found that mixtures of morphologies are present in the particulate material. The morphologies that have been found are:
spherical
hollow sphere
roughly spherical
cenospheres
packed porous network.

The morphologies are described in more detail below. The Applicant has found the density of the particles and the release of the active ingredients from the particles is dependent on the morphologies of the particles. Thus, the presence of significant amounts of differing morphologies in the particulate material results in non-uniform release of the active ingredient which situation is exacerbated by the presence of a relatively wide spread of particle sizes. Even in substantially homogeneous particulate materials, the dispersibility and dissolution of the material is non-uniform.

The Applicant has found that, surprisingly, by the selection of the production method and the parameters under which the particles are generated, it is possible to make particulate material having a selected morphology when more than one morphology is capable of being produced.

Accordingly, it is an object of the present invention to provide particulate material made by a spray process in which the particles are substantially mono-dispersed and have substantially the same morphology.

It is another object of the present invention to provide a process for making particulate material in which the particles are mono-dispersed and have substantially the same morphology.

According to a first aspect of the present invention, a particulate material made by a spray process has at least 80%, preferably at least 90% and more especially at least 95% of the particles of the same morphology, said particulate material having a mono-dispersivity index of not more than 1.2, preferably not more than 1.0 and more especially not more than 0.6.

According to a second aspect of the present invention, a particulate material made by a spray process has at least 80%, preferably at least 90% and more especially at least 95% of the particles of the same morphology, said particles having at least two components, a first component being at least one matrix material and a second component being at least one active ingredient retained by said first component, and said particulate material having a mono-dispersivity index of not more than 1.2, preferably not more than 1.0 and more especially not more than 0.6.

Although all of the previously mentioned morphologies can be generated in the particulate material of the present invention, it is preferred that particles have a morphology selected from hollow sphere, roughly spherical, cenospheres and packed porous network morphologies.

The mono-dispersivity index (MDI) is determined as follows:

$$MDI = \frac{( particle size 90 \% ) - ( particle size 10 \% )}{( particle size 50 \% )}$$

where:
(particle size 90%) is the size below which 90% by volume or weight of the particles lie:
(particle size 10%) is the size below which 10% by volume or weight of the particles lie; and
(particle size 50%) is the size below which 50% by volume or weight of the particles lie.

Although ideally, the MDI is as small as possible preferably approaches zero, from a practical point of view, the particulate material according to the invention has an MDI of greater than 0.05 and is more typically greater than 0.1, and is usually greater than 0.2.

Preferably, the particulate material according to the invention comprises particles that are substantially all of the same morphology, ie substantially 100% of the particles are of a particular morphology.

Preferably, the particulate material according to the invention comprises particles having a mean size in the range 50 μm to 3000 μm whether measured by volume or weight. The lower end of the mean size range is 50 μm and more preferably 100 μm. The upper end of the mean size range is 3000 μm and more preferably 2000 μm and more especially 1000 μm. Preferably, the particulate material comprises particles having a mean size in the range 100 μm to 600 μm, more especially 200 μm to 500 μm. Preferably, the mean sizes refer to volume mean sizes. When the morphology is spherical, the mean size is essentially refers to the diameter of the particles. For other morphologies, the mean size refers to the equivalent spherical diameter the particle would have if the material in it had a spherical morphology.

Preferably, the particulate material according to the invention is essentially dust free by which is meant it essentially does not contain any particles having a volume mean size less than 20 μm; more preferably it essentially does not contain any particles having sizes less than 50 μm and especially it essentially does not contain any particles having a volume mean size less than 80 μm. It will be understood this reference to the particulate material being essentially dust free is to the particulate material as made. In other words, it is not necessary to subject the particulate material according to the invention to a subsequent processing step to remove fines.

In the particulate material according to the invention, the particles, if homogeneous, or the first component and second components of the particles, if heterogeneous, may be selected from a wide range of materials depending on the application in which the particulate material is to be used.

When the particles are heterogeneous, the materials from which the first component is selected will enable the second component to be retained thereby, for example through encapsulation or binding together, to form discrete particles.

In some applications, the first component forms a material network that has interstices in which the second component is held. Such matrices may be inorganic or organic crystalline structures or may be amorphous or glassy-like structures. Examples of such matrices include inorganic salts such as sulphates, nitrates, acetates, carbonates etc and organic materials such as lactose, starches, sugars and organic acids.

In many applications, the particles have to be biocompatible. In particular, when the particles are heterogeneous, the first component has to be biocompatible. By “biocompatible” is meant that users of products containing the particulate material according to the invention experience no adverse affects. Examples of such uses are the use of encapsulated organoleptics in food, personal care and home care applications.

Suitable biocompatible materials for use as the first component may be selected from sugars, polysaccharides, starches and glycerides, especially di- and tri-glycerides. Such materials are also film forming.

Other applications may require the material of the particles, or when heterogeneous, the material of the first component to be film forming. Examples of such materials are polyvinyl acetate and ethylene vinyl acetate copolymers including mixture thereof with each other or with other materials such as latex, waxes, fats, lipids, and biopolymers.

In the particulate material according to the invention, when the particles are heterogeneous, the second component of the particles may be selected from a wide range of materials depending on the application in which the particulate material is to be used. The materials from which the second component are selected will be compatible with the first component in the sense of not being substantially detrimentally degraded by reaction with the first component, at least in the particles and the precursor formulations from which the particles are derived.

In the particulate material according to the invention, the second component of the particles may be selected from organoleptics, nanoscale fillers such as inorganic fine oxides, catalysts, skin benefit agents, nutrients, responsive polymers such as hydrogels.

In fragrance and flavour terms, the preferred organoleptic components are those that are most susceptible to attack without the protection offered by encapsulation e.g. highly volatile molecules, essential oils and fragrance chemicals which are susceptible to oxidative attack when used in bleach-containing detergents.

Hydrogels are polymers that absorb liquids and swell. The polymer chains are tangled and form porous networks similar to micro-sponges. Hydrogel particles are used to absorb the active ingredient and are then dispersed in a matrix material and subjected to a spray process to form particulate material according to the present invention. Polymers that form hydrogels typically contain hydroxyl, amine, amide, ether, carboxylate or sulphate groups or combinations of such groups. Typical of such polymers is α, β-poly (N-2-hydroxyethyl)-DL-aspartamide.

In the particulate material according to the invention, when the particles are heterogeneous, the second component of the particles may in itself be a binary or higher order particle. For example, the second component may be an active material encapsulated by a matrix to form a core shell particle. Examples of matrix materials are maltodextrin, starches, sugars, polysaccharides and fats.

More generally, examples of matrix-forming materials are:
starch, chemically and/or physically modified starch, starch systems containing other carbohydrates and/or polyols as described in EP 0 922 449 A2, U.S. Pat. Nos. 5,185,176; 4,977,252; 3,971,852, EP 0550067 (also, Modified Starches: Properties and Uses, O. B. Wurzburg, editor, CRC Press, Boca Raton, Fla. (1986).). Starch/oil composites (U.S. Pat. Nos. 5,882,713 and 5,676,994);
cellulose and cellulose derivatives (e.g. hydroxypropyl cellulose, carboxymethyl cellulose), alginate esters, alginic acid, carrageenans, agar, pectinic acids, plant gums or exudate gums (e.g. gum arabic, gum tragacanth and gum ghatti); hemicelluloses (cell wall polysaccharides such as D-xylans, L-Arabino-D-xylans, D-mannans, D-galacto-D-mannans and D-gluco-D-mannans);
cyclodextrins and their derivatives;
polyvinyl alcohols, polyethylene glycols, polyvinyl pyrrolidones, polyacrylic acid and it's derivatives, polyacrylamides, poly(ethylene oxides), styrene maleic anhydride copolymers, poly(vinyl sulfonic acids) (e.g. see U.S. Pat. Nos. 4,209,417; 4,339,356; 3,576,760). Other synthetic materials include polyurethanes, polyureas, melamine resins, melamine/urea resin;
gelatin, soy protein, whey protein, gelatin/gum Arabic; and
absorption of actives into inorganic particulates such as silicas, clays, zeolites followed by coating with any of the polymeric systems described above (e.g. see WO 02/064725, WO 01/40430A1); and

examples of active ingredients are:
adhesives, oils, , lubricants, fats, flavors, fragrances, colourants, vitamins, pharmaceuticals, inorganic or organic fillers, inks, sunscreens, moisturizers, biocidal substances or mixtures that accomplish a pest control or antifungal function, antibacterial materials, oil field additives, laundry additives such as fabric conditioners, enzymes, cosmetic materials, deodorants, hair conditioners and skin conditioners.

These examples are not exhaustive but are intended to illustrate the wide applicability of the invention.

Preferably, in the particulate material of the present invention, when the particles are heterogeneous, the second component comprises between 25 wt % to 55 wt %, more preferably 30 wt % to 50 wt %, of the particles.

A preferred embodiment of the present invention, when the particles are heterogeneous, comprises the first component being at least one matrix material selected from sugars, polysaccharides, starches and glycerides, especially di- and tri-glycerides, and a second component being at least one active ingredient retained by said first component and being an organoleptics.

Another preferred embodiment of the present invention, when the particles are heterogeneous, comprises the first component being at least one film-forming polymeric matrix material.

In terms of applications, slow dissolution of the particles and/or dispersion of active ingredients therein may be achieved by selecting film-forming materials and morphologies, ie spherical, hollow spheres and cenospheres; medium dissolution of the particles and/or dispersion of active ingredients therein may be achieved by selecting particles having a morphology suited to erosion mechanisms, ie roughly spherical; and fast dissolution of the particles and/or dispersion of active ingredients therein may be achieved by selecting the packed porous network morphology.

According to another aspect of the invention, the particulate material according to the present invention is made by projecting from a body of liquid comprising a precursor formulation for said particulate material an array of mutually divergent jets, disturbing the jets to cause break up thereof into streams of droplets of narrow size distribution, contacting the array of resulting droplet streams with a gas flow to reduce coalescence of the droplets in each stream and causing or allowing the droplets to solidify at least partially in flight, wherein said precursor formulation has a density in the range 800 kg/m³ to 1700 kg/m³, more preferably 1000 kg/m³ to 1700 kg/m³, a viscosity in the range 0.01 Pa·s to 1 Pa·s, more preferably in the range 0.06 Pa·s to 1 Pa·s and a surface tension in the range 0.01 N/m to 0.72 N/m, more preferably 0.02 N/m to 0.72 N/m and an Ohnesorge Number (Ohn) in the range 0.005 to 2.5, more especially in the range 0.008 to 1 and wherein the liquid jets have a Reynolds Number (Rej) in the range 10 to 5000, more especially in the range 10 to 2000.

The process, and apparatus in which the process may be carried out, is particularly described in WO 94/20204, which is incorporated herein by reference in its entirety.

The viscosity of the precursor formulation is normally determined at zero shear rate, but it may be determined at the wall shear rate of nozzles through which it passes to form the jets when it is higher than 0.1 Pa·s.

The Weber number of the precursor formulation is in the range 300 to 3000.

The process of the invention produces droplets having a volume mean droplet size in the range 50 μm to 3000 μm.

As described in WO 94/20204, the divergent jets may be disturbed to cause break up thereof by mechanical or acoustic vibration. In the method according to the present invention, the divergent jets are preferably disturbed to cause break up thereof by acoustic vibration. Preferably, the Weber frequency (fw) used for droplet generation is in the range 0.5 kHz to 100 kHz. Preferably, the flow in the jets is laminar.

A preferred embodiment of the method of the present invention, when the particles are heterogeneous and in which the first component is at least one matrix material selected from sugars, polysaccharides, starches and glycerides, especially di- and tri-glycerides comprises the liquid jets having a Rej in the range 10 to 5000 and the drops are generated using an fw in the range 2 kHz to 15 kHz.

Another preferred embodiment of the method of the present invention, when the particles are heterogeneous and in which the first component is at least one film-forming polymeric matrix material comprises the liquid jets having a Rej in the range 10 to 100 and the drops are generated using an fw in the range 10 kHz to 100 kHz.

Yet another preferred embodiment of the method of the present invention, when the particles are heterogeneous and wherein a material network is formed comprises the liquid jets having a Rej in the range 10 to 1000 and the drops are generated using an fw in the range 2 kHz to 50 kHz.

The present invention will now be described by way of example only with reference to the accompanying drawings in which:

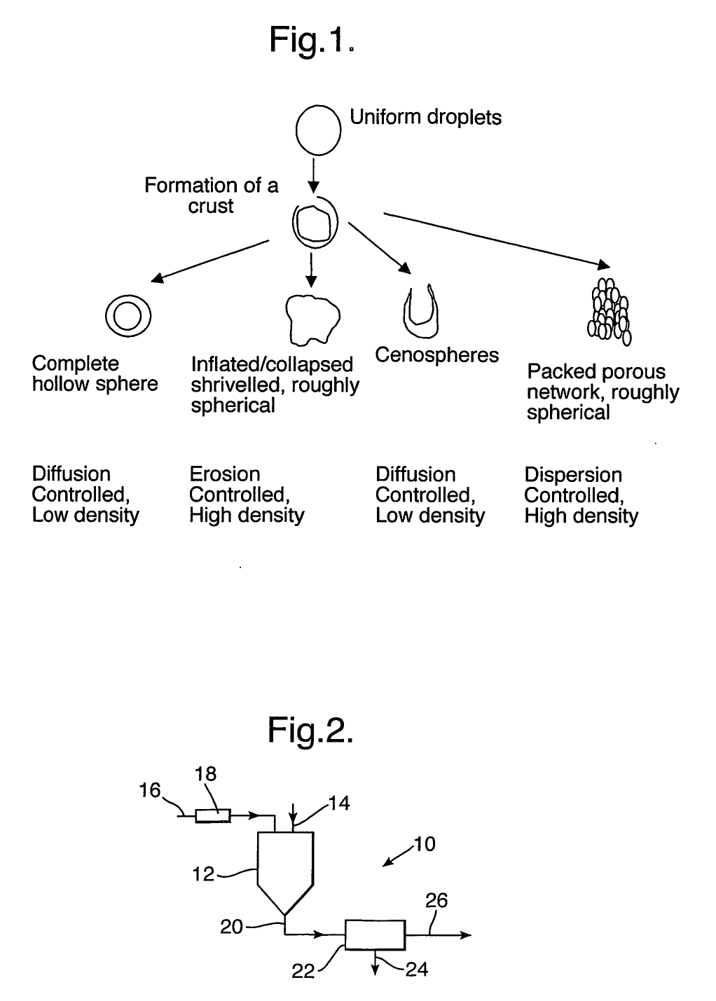

FIG. 1 is a schematic view of particle morphology formation;

FIG. 2 is a schematic view of spraying apparatus;

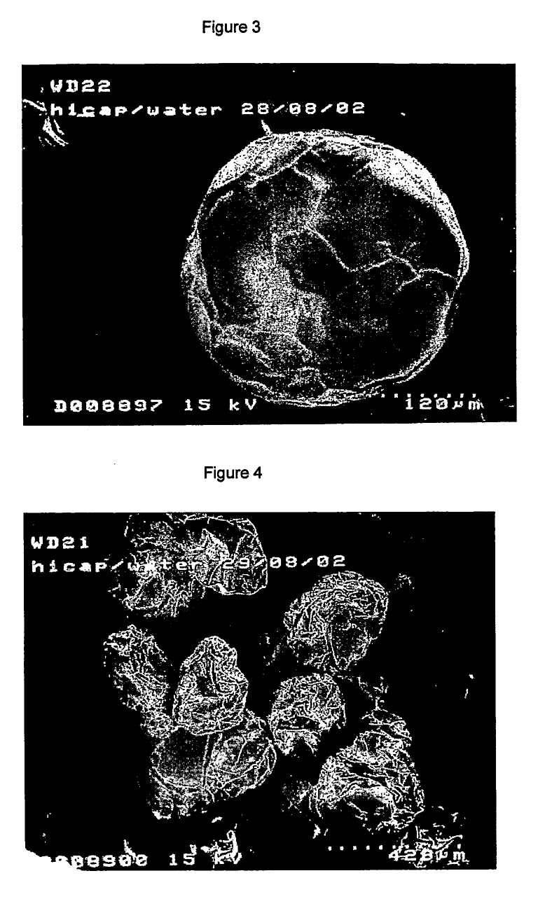

FIG. 3 is a micrograph of the particulate material of sample 1 described in Example 1;

FIG. 4 is a micrograph of the particulate material of sample 2 described in Example 1;

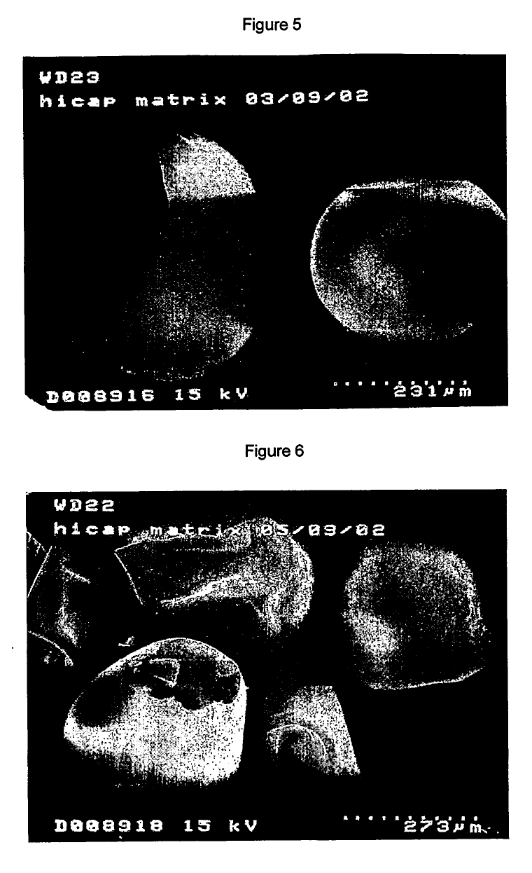

FIG. 5 is a micrograph of the particulate material of sample 4 described in Example 1;

FIG. 6 is a micrograph of the particulate material of sample 5 described in Example 1;

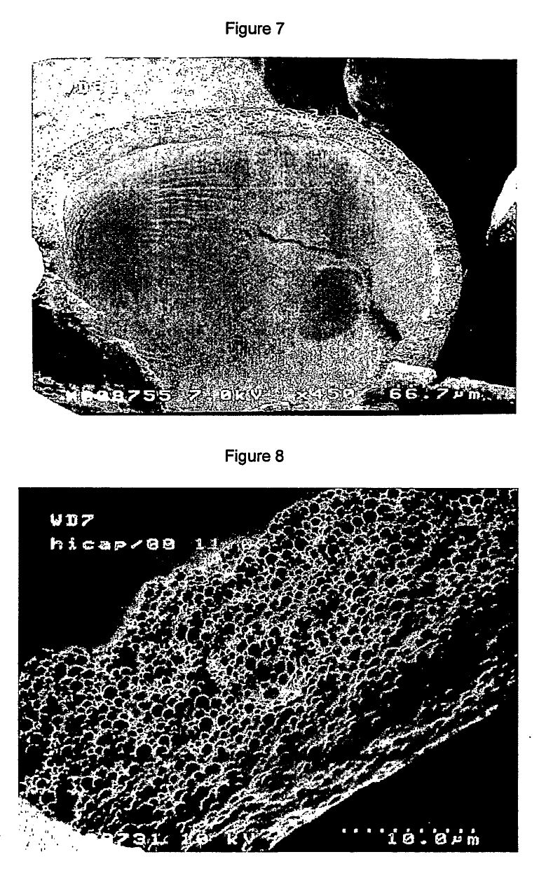

FIG. 7 is a micrograph of the particulate material of sample 6 described in Example 2;

FIG. 8 is a micrograph of the particulate material of sample 6 described in Example 2 taken at a higher magnification;

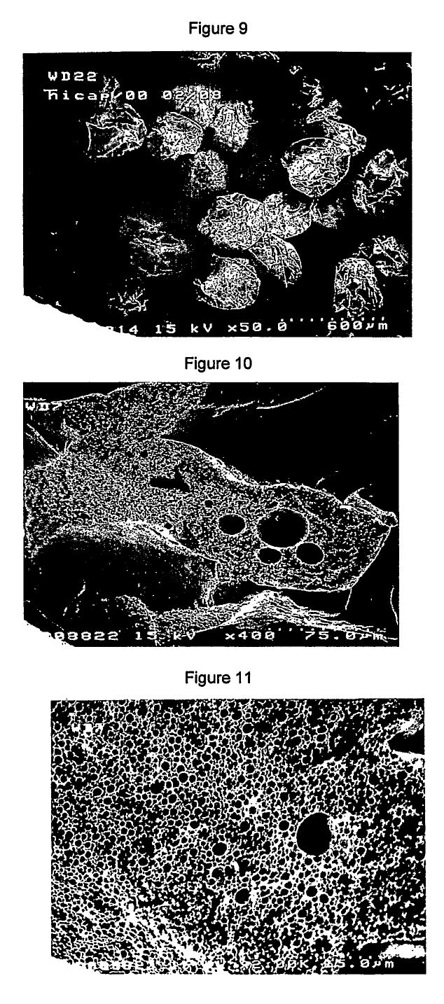

FIG. 9 is a micrograph of the particulate material of sample 12 described in Example 2;

FIGS. 10 and 11 are micrographs of the particulate material of sample 12 described in Example 2 taken at a higher magnification;

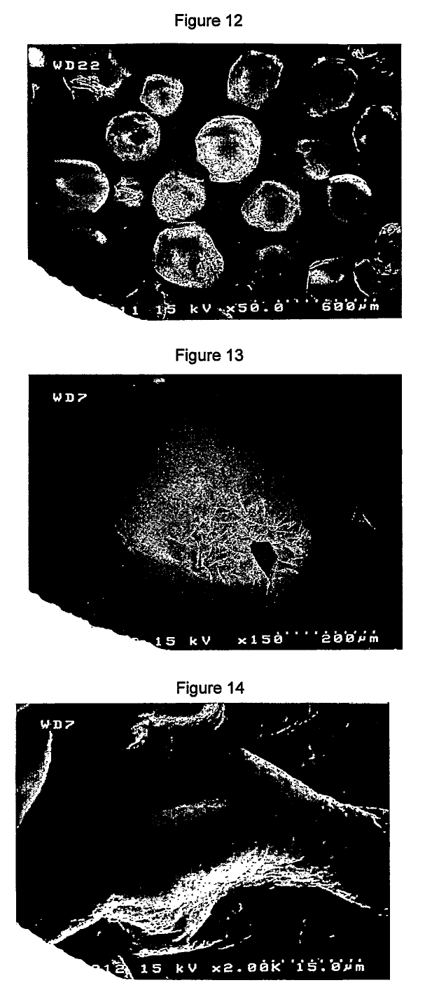

FIGS. 12 and 14 are micrographs similar to FIGS. 9 to 11 but of the particulate material of sample 11 described in Example 2;

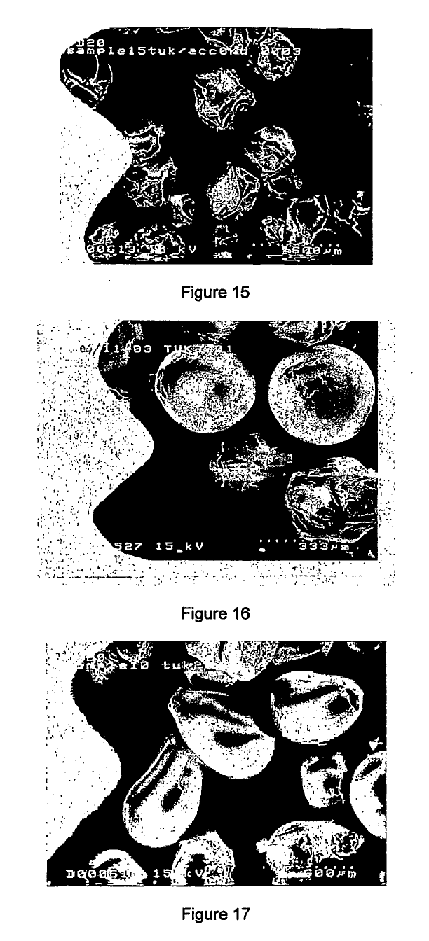

FIGS. 15 to 19 are, respectively, micrographs of the particulate materials of samples 21, 23 to 25 and 27 described in Example 4; and

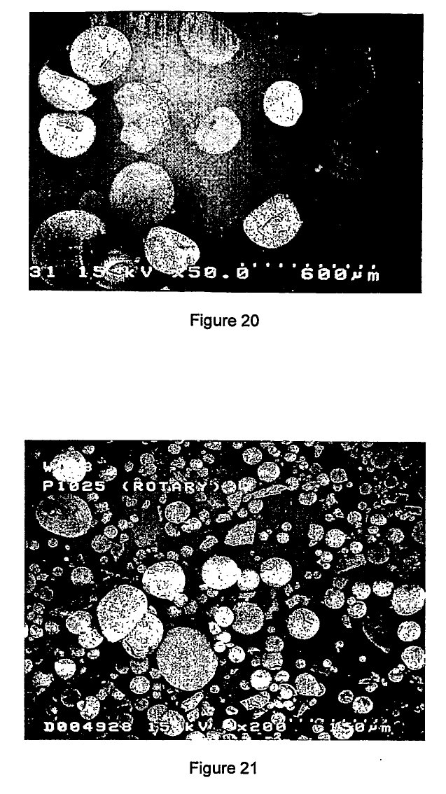

FIGS. 20 and 21 are, respectively, micrographs of the particulate materials of samples 31 and 32 described in Example 7.

As mentioned above, the morphologies are identified as:
spherical
hollow sphere
roughly spherical
cenospheres
packed porous network.

Referring to FIG. 1, the particulate material of the present invention preferably comprises particles of one of the morphologies shown. As shown, as the droplet is subjected to the gas flow, a crust is formed and each particle is then able to adopt one of the morphologies shown or a spherical morphology (not shown).

In the hollow sphere morphology, the particles generally have a shape close to or actually spherical and are hollow.

The roughly spherical morphology has particles that are generally round, ie sphere-like, in shape but they do not have a smooth surface. The surface appearance can vary from slightly rough, almost scale-like in appearance to very rough, irregular and knobbly or protrusion-covered surfaces. The particles are solid apart from a very small irregular central cavity, which arises as a result of density differences between the precursor formulation and the particle.

In the cenospheres morphology, the particles generally have a shape close to a sphere but are more likely to be slightly elongate or elliptical in appearance as compared to a true sphere and have an opening through the shell into the hollow centre.

As indicated in FIG. 1, the particle density varies across the morphologies as does the release mechanism of the active from the matrix.

In terms of applications, slow dissolution of the particles and/or dispersion of active ingredients therein may be achieved by selecting film-forming materials and morphologies, ie spherical, hollow spheres and cenospheres; medium dissolution of the particles and/or dispersion of active ingredients therein may be achieved by selecting particles having a morphology suited to erosion mechanisms, ie roughly spherical; and fast dissolution of the particles and/or dispersion of active ingredients therein may be achieved by selecting the packed porous network morphology.

A spherical morphology would be similar to the hollow sphere morphology shown in FIG. 1 except that it would be solid apart from a very small irregular central cavity, which arises as a result of density differences between the precursor formulation and the particle. In this instance, the particle would have high density and the release would be erosion controlled.

Referring to FIG. 2, spraying apparatus 10 has a spray tower 12 at the top of which is located a spray head (not shown). A feed line 14 supplies a precursor formulation to the spray head and a gas supply line 16 provides gas via a heater or cooler 18 to the tower 12 for the gas to impinge on droplet streams emitted from the spray head. An exhaust line 20 feeds the particles and exhaust gas to a separator 22 from which products off take 24 and a gas exhaust 26 exit.

As shown, the gas flow is concurrent with the droplet streams. In other arrangements, the gas flow may be counter-current with the gas entering the lower section of the spray tower 12 and being exhausted at its upper end above the spray head.

The spray head (not shown) may be a nozzle or rotary atomiser in conventional spray drying; alternatively, in accordance with the present invention, it is an accoustic spray head of the type described in WO 94/20204.

The invention will now be illustrated further with reference to the following Examples.

The following tests were performed on the samples:
bulk density measurement
dispersibility in water
SEM micrographies
residual moisture
retention of active
volume mean size.

The tests were carried out as follows:

Bulk Density

The following process was used to measure the bulk density of the spray-dried particulate material. A 100 ml beaker was weighted empty. Particulate material was added to the beaker, which was then tapped and shaken manually to cause the particles to settle and compact. This step was iterated until no further volume change was observed. The now full beaker was weighed. The weight of the empty beaker was subtracted from the weight of the full beaker to obtain the weight of the particulate material in the beaker and the bulk density was then calculated by dividing the weight (in kilograms) by 10⁻⁴ (the volume of the beaker in m³).

Dispersibility in Water

A measured amount of particulate material, approximately 1 g, was poured into a beaker containing a 100 g of demineralised water and its capacity to be completely dissolved or, on the contrary, to remain in particulate form or to aggregate into lumps was observed, together with the time needed to achieve the final condition.

Water Amount Measurement

The water amount in a material can highly influence its physical and chemical properties, causing for example its plasticisation and consequently reducing its glass transition temperature. In the Examples, the test was carried out to measure the residual moisture in the particulate material to enable an appropriate correction to be made to the measured active ingredient retention, which is at least partly dependent on this variable.

The moisture content of the particulate material was measured using a Karl-Fisher water measurement apparatus. To determine the moisture content in a non-aqueous solvent for the particulate material, ie ethanol, 100 μlitres of ethanol was injected into the apparatus and the moisture content of the solvent was measured. Using the same solvent batch, a measured amount, around 1 mg, of particulate material was dissolved in ethanol and 100 μlitres of the solution was injected into the Karl-Fisher apparatus and the moisture content of the solvent was measured. As the amount of water in the pure solvent and in the solution are known and the exact weight of the dissolved and injected particulate material is known, the residual moisture in the sample can be calculated.

Retention of Active Ingredient

In each test, 15 g of particulate material, together with several drops of silicon (as an antifoaming agent) and some boiling chips, were dispersed in 250 ml demineralised water in a distillation apparatus. The mixture was heated until the mixture was boiling. Heat was then applied to the mixture to maintain it at boiling temperature of the mixture for three hours. The apparatus was then allowed to cool to room temperature and the height of oil collected in the distillate collection column was measured using a precision calliper, and the percentage of oil retained was calculated using the formula:

$$\% retention = \frac{( X ml distillate ) ( specific gravity distillate )}{( \% w \text{/} w load ) ( dry weight particulate material )} ( 100 ) ( 1.04 )$$

The (1.04) in the formula is a correction factor for residual moisture, in this instance 4%.

### EXAMPLE 1

In this Example, a modified food starch derived from waxy maize sold under the trade name HI-CAP 100 by National Starch & Chemical Company, USA was used to make particulate materials according to the invention. This particular product has been found to be especially suited for the encapsulation of flavours, clouds, vitamins and spices, at high oil loading.

In this Example, the particulate material was made only using the HI-CAP 100. The HI-CAP 100 is formed into a dispersion which is then subjected to a spray process. The dispersion was prepared following the recommended procedure to prepare a dispersion of HI-CAP 100, namely:

| | |
|---|---|
| 1. | disperse HI-CAP 100 in water at ambient temperature with good |
| | agitation; |
| 2. | heat the dispersion preferably with agitation to 82° C. to ensure the |
| | HI-CAP 100 is completely dispersed; |
| 3. | cool the solution to ambient temperature. |

Several dispersions were made using HI-CAP 100 at solid concentration of 25%, 35% and 45% by weight, the balance being water; details of the dispersions are shown in Table 1.

The dispersions were then each subjected to a spray process using apparatus shown schematically in FIG. 2 and more specifically described in WO 94/20204. The process conditions of inlet and outlet temperature, as well as jets number and size for each sample are described in Table 2.

The resultant particulate samples were free flowing and non-dusty.

The bulk density of the resultant particulate samples were measured as described above and the results are shown in Table 3.

TABLE 1

| | | Density | Viscosity | Surface Tension |
|---|---|---|---|---|
| Sample | Cs % | [kg/m³] | (Pa · s) | (N/m) |
| 1 | 25% | 1100 | 0.07 | 0.03 |
| 2 | 35% | 1200 | 0.1 | 0.03 |
| 3 | 45% | 1300 | 0.15 | 0.03 |
| 4 | 35% | 1200 | 0.1 | 0.03 |
| 5 | 35% | 1200 | 0.1 | 0.03 |

TABLE 2

| | | Jet | | | | | |
|---|---|---|---|---|---|---|---|
| | | Reynolds | Frequency | Weber | Inlet T | Outlet | Jets no × diameter |
| Sample | Ohn | No | fw [kHz] | No | ° C. | T ° C. | [μm] |
| 1 | 0.8 | Approx 25 | 11 | 600 | 250 | 130 | 25 × 120 |
| 2 | 1 | Approx 18 | 7 | 600 | 210 | 120 | 15 × 150 |
| 3 | 2 | Approx 13 | 6 | 600 | 210 | 110 | 20 × 150 |
| 4 | 1 | Approx 20 | 10 | 900 | 210 | 110 | 30 × 120 |
| 5 | 1 | Approx 20 | 10 | 900 | 230 | 126 | 30 × 120 |

TABLE 3

| Sample | Density [kg/m³] |
|---|---|
| 1 | 340 |
| 2 | 460 |
| 3 | 340 |
| 4 | 450 |
| 5 | 400 |

All of the samples were tested for dispersibility as described above. All of the particulate material dispersed well in the water within a few minutes, there being no discernible amounts of particulate material present whether as added or aggregating in clumps.

Reference is now made to FIGS. 3 to 6.

The particles sizes are in the range from 250 to 500 microns depending on the nozzles used.

In FIGS. 3 and 4 (Samples 1and 2, respectively), roughly spherical morphologies are exhibited by the particulate material, each morphology being at the extreme of roughly spherical.

In FIG. 5, roughly spherical morphology is exhibited and in FIG. 6 cenospherical morphology is exhibited.

### EXAMPLE 2

Further samples of particulate materials according to the invention were made in accordance with the procedure described in Example 1, with the exception that an active ingredient was added to the process. The active ingredient was orange oil—Givaudan orange oil: code 705820, Single Fold, Citrus Valley Blend available from Givaudan, USA. In making the emulsion, the orange oil was added after step 3 with suitable agitation to disperse it in the water/starch dispersion, which dispersion was then subjected to an emulsification process using a Silverson mixer to create an emulsion in which the oil particles were of the order of 1 to 2 μm. The parts by weight of the components in the emulsion were as shown in Table 4.

TABLE 4

| Ingredient | Parts by Weight |
|---|---|
| HI-CAP 100 | 24 |
| Orange Oil | 16 |
| Water | 60 |

The emulsion had a density of 1300 kg/m3, a viscosity of 0.15 Pa·s and a surface tension of 0.03 N/m.

These samples were used to generate particulate under the conditions recorded in Table 5.

The resultant particulate samples were free flowing and non-dusty.

The bulk density, orange oil retention and residual moisture content were determined as described above and the results are shown in Table 6.

TABLE 5

| | | Jet | | | | | |
|---|---|---|---|---|---|---|---|
| | | Reynolds | Frequency | Weber | Inlet T | Outlet | Jet no × diameter |
| Sample | Ohn | No | fw [kHz] | No | ° C. | T ° C. | [μm] |
| 6 | 1 | 17.5 | 5.4 | 600 | 190 | 108 | 16 × 200 |
| 7 | 1 | 17.5 | 5.4 | 600 | 215 | 102 | 16 × 200 |
| 8 | 2 | 12 | 6 | 600 | 190 | 98 | 30 × 150 |
| 9 | 2 | 13 | 6 | 600 | 200 | 108 | 25 × 150 |
| 10 | 2 | 13 | 6 | 600 | 250 | 120 | 25 × 150 |
| 11 | 2 | 13 | 6 | 600 | 215 | 110 | 25 × 150 |
| 12 | 2 | 20 | 9 | 1500 | 210 | 115 | 15 × 150 |
| 13 | 1 | 17.5 | 5.4 | 600 | 210 | 120 | 15 × 200 |
| 14 | 1 | 17.5 | 5.4 | 600 | 220 | 115 | 15 × 200 |
| 15 | 2 | 14 | 9 | 900 | 190 | 112 | 15 × 120 |
| 16 | 2 | 13 | 9 | 900 | 200 | 107 | 20 × 120 |
| 17 | 1 | 17.5 | 5.4 | 600 | 180 | 89 | 15 × 200 |

TABLE 6

| | Density | Orange Oil | |
|---|---|---|---|
| Sample | [g/cm3] | Retention % | Residual moisture % |
| 6 | 480 | 93.40 | 3.6 |
| 7 | 510 | 89.80 | 4.48 |
| 8 | 470 | 96.40 | 2.7 |
| 9 | 430 | 93.50 | 3.0 |
| 10 | 450 | 95.80 | 2.9 |
| 11 | 270 | 97.50 | 2.57 |
| 12 | 500 | 94.40 | 2.83 |
| 13 | 500 | 94.36 | 3.1 |
| 14 | 450 | 95.60 | 3.3 |
| 15 | 440 | 96.60 | 2.60 |
| 16 | 470 | 98.20 | 2.58 |
| 17 | 295 | 94.80 | 2.63 |
| 18 | 530 | 89.20 | 4.70 |

All of the samples were tested for dispersibility as described above. All of the particulate material dispersed well in the water within a few minutes, there being no discernible amounts of particulate material present whether as added or aggregating in clumps.

Reference is now made to FIGS. 7 to 11.

In FIGS. 7 and 8 (Sample 6), the particulate material exhibits hollow spherical morphology, the voids left by the evaporation of encapsulated oil particles clearly being visible in the wall structure of the hollow spherical particle. In FIGS. 9 to 11 (Sample 12), the particulate material exhibits roughly spherical morphology, the encapsulated oil particles clearly being visible in the wall structure of the roughly spherical particle. In FIGS. 12 to 14 (Sample 11), the particulate material exhibits cenospherical morphology, the encapsulated oil particles clearly being visible in the wall structure of the cenospherical particle.

### EXAMPLE 3

Example 1 was repeated but using a modified starch sold under the trade name Tuk 2001 by National Starch & Chemical Co, USA was used to make particulate materials according to the invention. The details of the dispersion samples made using Tuk 2001 starch material are given in Table 7 below.

A comparative sample 20 was also prepared.

TABLE 7

| | | Density | Viscosity | Surface Tension |
|---|---|---|---|---|
| Sample | Cs % | [kg/m³] | (Pa · s) | (N/m) |
| 18 | 34% | 1200 | 0.1 | 0.03 |
| 19 | 34% | 1200 | 0.1 | 0.03 |
| 20* | 34% | 1200 | 0.1 | 0.03 |

*Comparative

The dispersion samples 18 and 19 were each then subjected to a spray process in accordance with the invention using the conditions shown in Table 8.

Sample 20 was subjected to a rotary spray process using a rotary wheel atomiser from Niro in which the inlet temperature was 230° C., the outlet temperature was 111° C. and the rotary wheel speed was 2000 rpm.

The resultant particulate samples 18 and 19 were free flowing and non-dusty. In contrast, sample 20 was extremely dusty and not free flowing.

TABLE 8

| | | Jet | | | | | |
|---|---|---|---|---|---|---|---|
| | | Reynolds | Frequency | | Inlet T | Outlet | Jets no × diameter |
| Sample | Ohn | No | [kHz] | fw | ° C. | T ° C. | [μm] |
| 18 | 2 | 10 | 9 | 600 | 250 | 110 | 21 × 120 |
| 19 | 1 | 18 | 6 | 600 | 250 | 120 | 10 × 200 |

The bulk density of the resultant particulate samples were measured as described above together with the volume mean size (VMS) and the mono-dispersivity index (MDI) and the results are shown in Table 9.

TABLE 9

| Sample | VMS [μm] | MDI | Density [kg/m³] |
|---|---|---|---|
| 18 | 275 | 0.4 | 370 |
| 19 | 433 | 0.6 | 270 |
| 20* | 150 | 1.4 | 260 |

*Comparative

The samples were tested for dispersibility as described above. In respect of samples 18 and 19, all of the particulate material dispersed well in the water within a few minutes, there being no discernible amounts of particulate material present whether as added or aggregating in clumps. In contrast, sample 20 took a relatively long time, ie of the order of 45 minutes, to disperse, forming aggregates in the process.

The particulate material of sample 18 was essentially completely of cenospherical morphology whereas the particulate material of sample 19 was essentially completely of a denser, roughly spherical morphology. The particulate material of sample 20 exhibited mixed morphologies.

### EXAMPLE 4

Example 2 was repeated using the Tuk 2001 starch material identified in Example 3 and an acord fragrance available from Quest Fragrances, Ashford, Kent, GB. Emulsion samples were made as shown in Table 10. In contrast to the emulsions in Example 2, these emulsions were prepared by weighing the ingredients into a tank, recirculating the ingredients through an inline mixer to form a premix and then passing the premix through an APV Rannie 2-stage high pressure homogeniser.

TABLE 10

| | | Density | Viscosity | Surface Tension |
|---|---|---|---|---|
| Sample | Cs % | [kg/m³] | (Pa · s) | (N/m) |
| 21 | 40 | 1250 | 0.17 | 0.03 |
| 22 | 50 | 1300 | 0.2 | 0.03 |
| 23 | 50 | 1300 | 0.2 | 0.03 |
| 24 | 50 | 1300 | 0.2 | 0.03 |
| 25* | 40 | 1250 | 0.17 | 0.03 |
| 26* | 50 | 1300 | 0.2 | 0.03 |
| 27* | 50 | 1300 | 0.2 | 0.03 |

*Comparative

The emulsion samples 21 to 24 were each then subjected to a spray process in accordance with the invention using the conditions shown in Table 11.

Samples 25 and 26 were subjected to a rotary spray process as described in Example 3. Sample 27 was subjected to a two-fluid nozzle spray process in which pressurised air is used to atomise the emulsion. The run conditions for sample 27 were inlet temperature=230° C., outlet temperature=120° C. and air pressure=2 bar.

TABLE 11

| | | Jet | | | | | |
|---|---|---|---|---|---|---|---|
| | | Reynolds | Frequency | Weber | Inlet T | Outlet | Jets no × diameter |
| Sample | Ohn | No | fw [kHz] | No | ° C. | T ° C. | [μm] |
| 21 | 2 | 9 | 7 | 600 | 190 | 108 | 21 × 120 |
| 22 | 2 | 13 | 4 | 900 | 190 | 120 | 10 × 200 |
| 23 | 2.4 | 15 | 8 | 1500 | 190 | 110 | 13 × 150 |
| 24 | 1.6 | 12 | 5 | 800 | 190 | 115 | 15 × 170 |

The resultant particulate samples 21 to 24 were free flowing and non-dusty. In contrast, samples 25 to 27 were extremely dusty and not free flowing.

The bulk density of the resultant particulate samples were measured as described above and the mono-dispersivity index (MDI) and the results are shown in Table 12. The weight mean size (WMS) was also determined and is also shown in Table 12. The WMS was determined by sieving 100 g of particulate material using 6 sieves having mesh sizes in the range 710 to 125 μm for 30 minutes and plotting the resultant weight distribution of particles at each size to enable the weight mean size to be interpolated.

TABLE 12

| Sample | WMS [μm] | MDI | Density [kg/m³] |
|---|---|---|---|
| 21 | 230 | 0.4 | 610 |
| 22 | 360 | 0.6 | 510 |
| 23 | 320 | 0.8 | 530 |
| 24 | 330 | 0.9 | 410 |
| 25* | 380 | 1.3 | 420 |
| 36* | 375 | 1.4 | 460 |
| 27* | 290 | 1.6 | 380 |

*Comparative

The samples were tested for dispersibility as described above. In respect of samples 21 to 24, all of the particulate material dispersed well in the water within a few minutes, there being no discernible amounts of particulate material present whether as added or aggregating in clumps. In contrast, samples 25 to 27 took a relatively long time, ie of the order of 35 minutes, to disperse, forming aggregates in the process.

The morphologies of the samples in this Example 4 are shown in FIGS. 15 to 19. As can be seen, the particles in FIGS. 15 (sample 21) and 16 (sample 23), exhibit essentially completely roughly spherical morphology having a very narrow size distribution; the particles of sample 21 having a more shrivelled appearance than the particles of sample 23. Sample 22 was very similar to sample 21.

Sample 24 (FIG. 17) exhibited essentially completely cenospherical morphology having a very narrow size distribution.

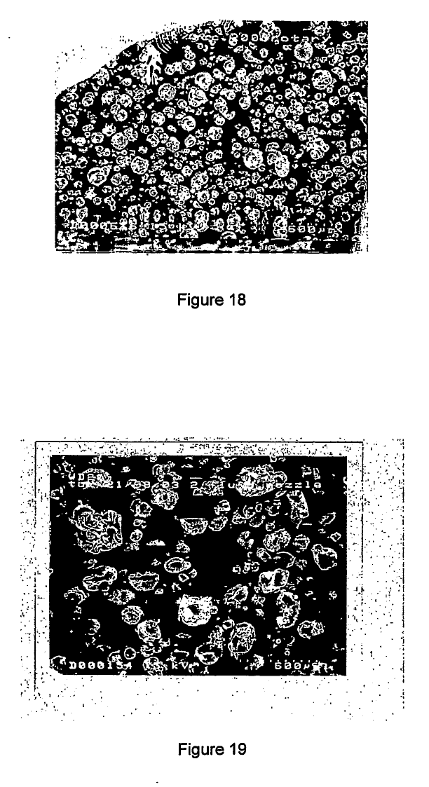

In contrast, FIGS. 18 (sample 25) and 19 (sample 27) show mixed morphologies and wide size distributions. Sample 26 was very similar to sample 25.

### EXAMPLE 5

Example 2 was repeated but using Capsul, an encapsulant obtained from Quest Foods, Naarden, Holland, maltodextrin, sugar and lemon oil obtained from Quest Foods. The emulsion compositions are shown in Table 13; the proportions are in parts by weight. The resultant emulsions had a 50% solids concentration and a viscosity of 0.15 PA·s.

TABLE 13

| Sample | Capsul | Maltodextrin | Sugar | Water | Lemon Oil |
|---|---|---|---|---|---|
| 28 | 500 | 250 | 250 | 1000 | 332 |
| 29 | 500 | 250 | 250 | 1000 | 332 |

The emulsion samples 28 and 29 were each then subjected to a spray process in accordance with the invention using the conditions shown in Table 14.

TABLE 14

| | | Jet | | | | | |
|---|---|---|---|---|---|---|---|
| | | Reynolds | Frequency | Weber | Inlet T | Outlet | Jets no × diameter |
| Sample | Ohn | No | fw [kHz] | No | ° C. | T ° C. | [μm] |
| 28 | 1 | 12 | 6.4 | 600 | 180 | 100 | 25 × 150 |
| 29 | 1 | 12 | 6.4 | 600 | 200 | 108 | 25 × 150 |

The resultant particulate samples 28 and 29 were free flowing and non-dusty

The particulate samples 28 and 29 were tested for dispersibility as described above. All of the particulate material dispersed well in the water within a few minutes, there being no discernible amounts of particulate material present whether as added or aggregating in clumps.

Sample 28 exhibited essentially complete cenospherical morphology whereas sample 9 exhibited essentially complete roughly spherical morphology, the particles having a shrivelled appearance; both samples exhibited a narrow size distribution.

### EXAMPLE 6

Example 1 was repeated but using magnesium sulphate obtained from British Drug Houses (BDH). The solution is shown in Table 15; the proportions are in parts by weight.

The emulsion sample 30 was then subjected to a spray process in accordance with the invention using the conditions shown in Table 16.

TABLE 15

| | Magnesium | | Density | Viscosity | Surface Tension |
|---|---|---|---|---|---|
| Sample | sulphate | Water | [kg/m³] | (Pa · s) | (N/m) |
| 30 | 400 | 1000 | 1100 | 0.008 | 0.04 |

TABLE 16

| | | Jet | | | | | |
|---|---|---|---|---|---|---|---|
| | | Reynolds | Frequency | Weber | Inlet T | Outlet | Jets no × diameter |
| Sample | Ohn | No | fw [kHz] | No | ° C. | T ° C. | [μm] |
| 30 | 0.1 | 280 | 11 | 600 | 280 | 167 | 8 × 200 |

The resultant particulate sample 30 was free flowing and non-dusty

The bulk density of the resultant particulate samples were measured as described above together with the weight mean size (WMS) and the mono-dispersivity index (MDI) and the results are shown in Table 17.

TABLE 17

| Sample | WMS [μm] | MDI | Density [kg/m³] |
|---|---|---|---|
| 30 | 387 | 0.6 | 300 |

The particulate sample 30 was tested for dispersibility as described above. All of the particulate material dispersed well in the water within a few minutes, there being no discernible amounts of particulate material present whether as added or aggregating in clumps.

Sample 30 exhibited essentially completely a roughly spherical morphology and had a narrow size distribution.

### EXAMPLE 7

Example 1 was repeated but using a polyvinylacetate (PVA) available under the trade name Elotex WRRP by Elotex, a division of National Starch & Chemical Co, USA. The emulsion compositions were made up using the PVA and water and are shown in Table 18; the proportions are in parts by weight.

TABLE 18

| | | Density | Viscosity | Surface Tension |
|---|---|---|---|---|
| Sample | Cs % | [kg/m³] | (Pa · s) | (N/m) |
| 31 | 42.65 | 1070 | 0.025 | 0.02 |
| 32* | 42.65 | 1070 | 0.025 | 0.02 |

*Comparative

The emulsion sample 31 was then subjected to a spray process in accordance with the invention using the conditions shown in Table 19. Emulsion sample 32 was subjected to a rotary spray process as described in Example 3.

TABLE 19

| | | Jet | | | | | |
|---|---|---|---|---|---|---|---|
| | | Reynolds | Frequency | Weber | Inlet T | Outlet | Jets no × diameter |
| Sample | Ohn | No | fw [kHz] | No | ° C. | T ° C. | [μm] |
| 31 | 0.4 | 64 | 8 | 800 | 174 | 100 | 48 × 150 |

The resultant particulate sample 31 was free flowing and non-dusty in contrast to the resultant particulate sample 32 which was dusty and not free flowing.

The bulk density of the resultant particulate samples were measured as described above together with the weight mean size (WMS) and the mono-dispersivity index (MDI) and the results are shown in Table 20.

TABLE 20

| Sample | WMS [μm] | MDI | Density [kg/m³] | Residual moisture % |
|---|---|---|---|---|
| 31 | 250 | 1.1 | 400 | 0.99 |
| 32 | 80 | 1.4 | 400 | 1.4 |

The morphologies of these samples are shown in FIGS. 20 and 21 respectively. As can be seen from FIG. 20, sample 31 is shown to have essentially a completely cenospherical morphology and a narrow size distribution in contrast to the mixed morphologies and sizes exhibited by comparative sample 32 as shown in FIG. 21.

1. A particulate material made by a spray process has at least 80%, preferably at least 90% and more especially at least 95% of the particles of the same morphology, said particulate material having a mono-dispersivity index of not more than 1.2, preferably not more than 1.0 and more especially not more than 0.6.

2. A particulate material made by a spray process has at least 80%, preferably at least 90% and more especially at least 95% of the particles of the same morphology, said particles having at least two components, a first component being at least one matrix material and a second component being at least one active ingredient retained by said first component, and said particulate material having a mono-dispersivity index of not more than 1.2, preferably not more than 1.0 and more especially not more than 0.6.

3. A particulate material according to claim 1 in which the particles have a morphology selected from hollow sphere, roughly spherical, cenospheres and packed porous network morphologies.

4. A particulate material according to claim 1 in which the particles have a mono-dispersivity index of greater than 0.05 and is more typically greater than 0.1, and is usually greater than 0.2.

5. A particulate material according to claim 1 in comprising particles that are substantially all of the same morphology.

6. A particulate material according to claim 1 comprising particles having a volume mean size in the range to 3000 μm.

7. A particulate material according to claim 6 comprising particles having a mean size in the range to 2000 and more especially in the range 100 μm to 2000 μm and more especially in the range 100 μm to 1000 μm.

8. A particulate material according to claim 6 comprising particles having a mean size in the range 100 μm to 600 μm, more especially 200 μm to 500 μm.

9. A particulate material according to claim 1 which is essentially dust free.

10. A particulate material according to claim 1 which essentially does not contain any particles having a volume mean size less than 20 μm; more preferably essentially does not contain any particles having sizes less than 50 μm and especially essentially does not contain any particles having a volume mean size less than 80 μm.

11. A particulate material according to claim 1 in which the particles are biocompatible.

12. A particulate material according to claim 11 in which the particles or the first component thereof are selected from sugars, polysaccharides, starches and glycerides, especially di- and tri-glycerides.

13. A particulate material according to claim 1 in which the material from which the particles or the first component thereof is made is film forming.

14. A particulate material according to claim 13 in which the first component is selected from polyvinyl acetate and ethylene vinyl acetate copolymers including mixture thereof with each other or with other materials.

15. A particulate material according to claim 2 in which the first component forms a material network that has interstices in which the second component is held.

16. A particulate material according to claim 2 in which the second component is selected from materials that are compatible with the first component.

17. A particulate material according to claim 2 in which the second component of the particles is a binary or higher order particle.

18. A particulate material according to claim 2 in which the second component comprises between 25 wt % to 55 wt %, more preferably between 30 wt % to 50 wt % of the particles.

19. A particulate material according to claim 2 which comprises the first component being at least one matrix material selected from sugars, polysaccharides, starches and glycerides, especially di- and tri-glycerides, and the second component being at least one active ingredient retained by said first component and being an organoleptic.

20. A particulate material according to claim 2 which comprises the first component being at least one film-forming polymeric matrix material.

21. A method of making a particulate material according to claim 1 comprising projecting from a body of liquid comprising a precursor formulation for said particulate material an array of mutually divergent jets, disturbing the jets to cause break up thereof into streams of droplets of narrow size distribution, contacting the array of resulting droplet streams with a gas flow to reduce coalescence of the droplets in each stream and causing or allowing the droplets to solidify at least partially in flight, wherein said precursor formulation has a density in the range 800 kg/m³ to 1700 kg/m³, more preferably 1000 kg/m³ to 1700 kg/m³ a viscosity in the range 0.01 Pa·s to 1 Pa·s, more preferably in the range 0.06 Pa·s to 1 Pa·s and a surface tension in the range 0.01 N/m to 0.72 N/m, more preferably 0.02 N/m to 0.72 N/m and an Ohnesorge Number in the range 0.005 to 2.5, more especially in the range 0.008 to 1 and wherein the liquid jets have a Reynolds Number (Rej) in the range 10 to 5000, more especially in the range 10 to 2000.

22. A method according to claim 21 in which the divergent jets are disturbed to cause break up thereof by acoustic vibration.

23. A method according to claim 22 in which the Weber frequency (fw) used for droplet generation is in the range 0.5 kHz to 100 kHz.

24. A method according to claim 21 in which the flow in the jets is laminar.

25. A method according to claim 21 in which, when the particles comprise first and second components, the first component is at least one matrix material selected from sugars, polysaccharides, starches and especially di- and tri-glycerides and the method comprises the liquid jets having a Rej in the range 10 to 5000 and the drops are generated using an fw in the range 2 kHz to 15 kHz.

26. A method according to claim 21 in which, when the particles comprise first and second components, the first component is at least one film-forming polymeric matrix material and the method comprises the liquid jets having a Rej in the range 10 to 100 and the drops are generated using an fw in the range 10 kHz to 100 kHz.

27. A method according to claim 21 wherein a material network is formed comprises the liquid jets having a Rej in the range 10 to 1000 and the drops are generated using an fw in the range 2 kHz to 50 kHz.
